(19) United States
(12) Patent Application Publication
(10) Pub. No.: US 2015/0375597 A1
(43) Pub. Date: Dec. 31, 2015

(54) Portable Air Conditioning Device for Vehicles

(71) Applicant: Shea P. Callahan, Hereford, AZ (US)

(72) Inventor: Shea P. Callahan, Hereford, AZ (US)

(21) Appl. No.: 14/755,357

(22) Filed: Jun. 30, 2015

Related U.S. Application Data
(60) Provisional application No. 62/018,789, filed on Jun. 30, 2014.

(51) Int. Cl. B60H 1/00; F24F 5/00

(52) U.S. Cl. CPC B60H 1/00478; F24F 5/0042

(57) ABSTRACT

Disclosed is a portable air conditioning device for vehicles. The device includes a plurality of air duct hoses and an exhaust hose that is connected to a housing member that encloses a thermoelectric cooling module capable of producing heated or cooled air, and a fan with a fan speed control switch. The air duct hoses supply cool air to the interior of a vehicle while the exhaust hose releases heat to the outdoors. The device may be internally powered via a battery or externally powered via a power adaptor or outlet. The device may be conveniently placed inside of a vehicle and secured in place via a strap system disposed thereon. In this way, the device may be ideally used with existing vehicles lacking an operable air conditioning and/or heating system. Additionally, the device may be used to supplement an operable air conditioning system for a vehicle.

### CROSS REFERENCE TO RELATED APPLICATION

This application claims the benefit of U.S. Provisional Application No. 62/018,789 filed on Jun. 30, 2014. The above identified patent application is herein incorporated by reference in its entirety to provide continuity of disclosure.

### BACKGROUND OF THE INVENTION

1. Field of the Invention

The present invention relates to an air conditioning device for vehicles. More specifically, the present invention pertains to a portable air conditioning device that utilizes a thermoelectric cooling module to circulate cool air or heated air within the interior of a vehicle to increase comfort to the vehicle passengers. The present air conditioning device may be used with existing vehicles having no air conditioner or heating unit or to replace an inoperable air conditioner or heating unit.

Vehicle air conditioning systems cool the occupants of a vehicle in hot weather, and have come into wide and popular use throughout the automobile industry. Most air conditioning systems are installed into vehicles during the manufacturing process. These systems use an engine-mounted compressor, driven off of the crankshaft of the engine via a drive belt, with an evaporator in the trunk of a vehicle to deliver cold air through the rear parcel shelf and overhead vents. In this way, vehicle air conditioning systems move heat from inside of a vehicle to the outdoors. Conventional air conditioning systems, however, decrease the fuel efficiency of a vehicle because these systems use energy supplied by the alternator, which comes from the engine that uses the fuel. The air conditioning systems cannot function properly when the vehicle is not running because the belt that engages the compressor, which is used to compress the coolant, will only run with the engine started.

Additionally, diagnosing and repairing vehicle air conditioning systems can be very complicated. If a vehicle air conditioning system is not fixed, however, passengers can be subjected to excessive heat, which may be potentially dangerous during hot weather. Nonetheless, it is impracticable and expensive to install an air conditioning system in existing vehicles. More specifically, installing a new air conditioning system to an existing vehicle requires a user to modify the structure of the vehicle. It is recognized that portable cooling units may be used as a means of cooling the interior of a vehicle. It is submitted, however, that existing portable cooling units are bulky and lack the means to secure the cooling unit to the inside of a vehicle, and further lack means to effectively ventilate cool and hot air.

2. Description of the Prior Art

Devices have been disclosed in the prior art that relate to air conditioning systems for vehicles, and further to those emphasizing portability of the system. These include devices that have been patented and published in patent application publications. Some of these patents describe air conditioners that are built into vehicles during the manufacturing process. Others describe portable air conditioner devices that utilize air vents disposed on the housing of the air conditioner. These devices, however, are not specifically designed to be used with existing vehicles and lack a flexible air duct system to facilitate the direction of the air flow within the interior of a vehicle. The following is a list of devices deemed most relevant to the present disclosure, which are herein described for the purposes of highlighting and differentiating the unique aspects of the present invention, and further highlighting the drawbacks existing in the prior art.

For example, U.S. Pat. No. 8,418,477 to Klein and U.S. Pat. No. 6,662,572 to Howard disclose solar-thermoelectric air-conditioning units that comprises a solar photovoltaic panel that is positioned in a window or another exterior portion of a vehicle to provide current to a thermoelectric assembly, which pumps excess heat out of the interior of the vehicle. Additionally, the solar photovoltaic panel blocks a portion of sun rays from entering the vehicle. Klein, however, does not disclose an air conditioning unit that comprises thermoelectric cooling module that includes aluminum plates.

U.S. Pat. No. 3,187,043 to Zoleta, U.S. Pat. No. 3,138,934 to Roane, and U.S. Pat. No. 7,866,164 to Rice disclose automobile air conditioning systems that comprises thermoelectric devices. Zoleta discloses a Seebeck generator that is operated via an engine exhaust. The generator supplies electrical current to a Peltier unit that is located in a vehicle cabin for removing heat from the same. Roane discloses finned aluminum plates and a fan for generating an air flow. Rice discloses a housing with an elongated vent for allowing air to exit therethrough. While the foregoing devices disclose thermoelectric devices, these devices do not disclose a housing that is in fluid communication with an air duct system.

Finally, U.S. Pat. No. 4,823,554 to Trachtenberg discloses a vehicle thermoelectric cooling and heating food and drink appliance that comprises Peltier elements. The design and intent of the Trachtenberg devices, however, differ from the present invention in that Trachtenberg discloses a device for keeping food and beverage items cool. Thus, Trachtenberg is inoperable to cool the inside of a vehicle cabin. In contrast, the present invention comprises an air conditioning device for cooling or heating the inside of a vehicle cabin.

These prior art devices have several known drawbacks. The present invention is adapted to provide air conditioning system for vehicles without an existing air conditioning system or for vehicles without an operable air conditioning system. The present invention does not require structural modification to the vehicle, and offers the flexibility of being able to be moved as necessary. The present invention helps to cool the interior of a vehicle to provide a comfort to the passengers. The housing is designed to be compact so that it may be placed in the interior of a vehicle, while the strap secures the device in place. Additionally, the air duct hoses can be easily maneuvered to direct air flow to the driver and the passenger.

It is therefore submitted that the present invention substantially diverges in design elements from the prior art, which overcomes the disadvantages of the prior art devices, and consequently it is clear that there is a need in the art for an improvement to existing air conditioning systems for vehicles. In this regard the instant invention substantially fulfills these needs.

### SUMMARY OF THE INVENTION

In view of the foregoing disadvantages inherent in the known types of air conditioning systems for vehicles now present in the prior art, the present invention provides a new improvement to a portable air conditioning device for vehicles wherein the same can be utilized for cooling or heating the interior of a vehicle.

It is therefore an object of the present invention to provide a new and improved portable air conditioning device for vehicles that has all of the advantages of the prior art and none of the disadvantages.

It is another object of the present invention to provide a new and improved portable air conditioning device for vehicles having an air duct system that includes one or more flexible air duct hoses with adjustable vents to control the direction of the air flow to the occupants of a vehicle.

Another object of the present invention is to provide a new and improved portable air conditioning device for vehicles having a fan with a fan speed control switch that is adapted to control the amount of air flow to the occupants of a vehicle.

Yet another object of the present invention is to provide a new and improved portable air conditioning device for vehicles that is compact in design for use with new or existing vehicles without modifying the structure of the vehicles.

Still yet another object of the present invention is to provide a new and improved portable air conditioning device for vehicles that is externally powered via a retractable power supply adapter or a retractable outlet plug.

Still yet another object of the present invention is to provide a new and improved portable air conditioning device for vehicles that utilizes a thermoelectric cooling module.

Still yet another object of the present invention is to provide a new and improved portable air conditioning device for vehicles that includes a strap system to secure the device to the interior of a vehicle.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and in manner in which it may be made and used may be better understood after a review of the following description, taken in connection with the accompanying drawings wherein like numeral annotations are provided throughout.

FIG. 1 shows a perspective view of an embodiment of the present invention.

FIG. 2 shows a perspective view of another embodiment of the present invention.

FIG. 3 shows a cross sectional view of the present invention.

FIG. 4 shows a view of the present invention as placed inside of a vehicle.

### DETAILED DESCRIPTION OF THE INVENTION

Reference is made herein to the attached drawings. Like reference numerals are used throughout the drawings to depict like or similar elements of the portable air conditioning device for vehicles. For the purposes of presenting a brief and clear description of the present invention, the preferred embodiment will be discussed as used for heating or cooling the interior of a vehicle. The figures are intended for representative purposes only and should not be considered to be limiting in any respect.

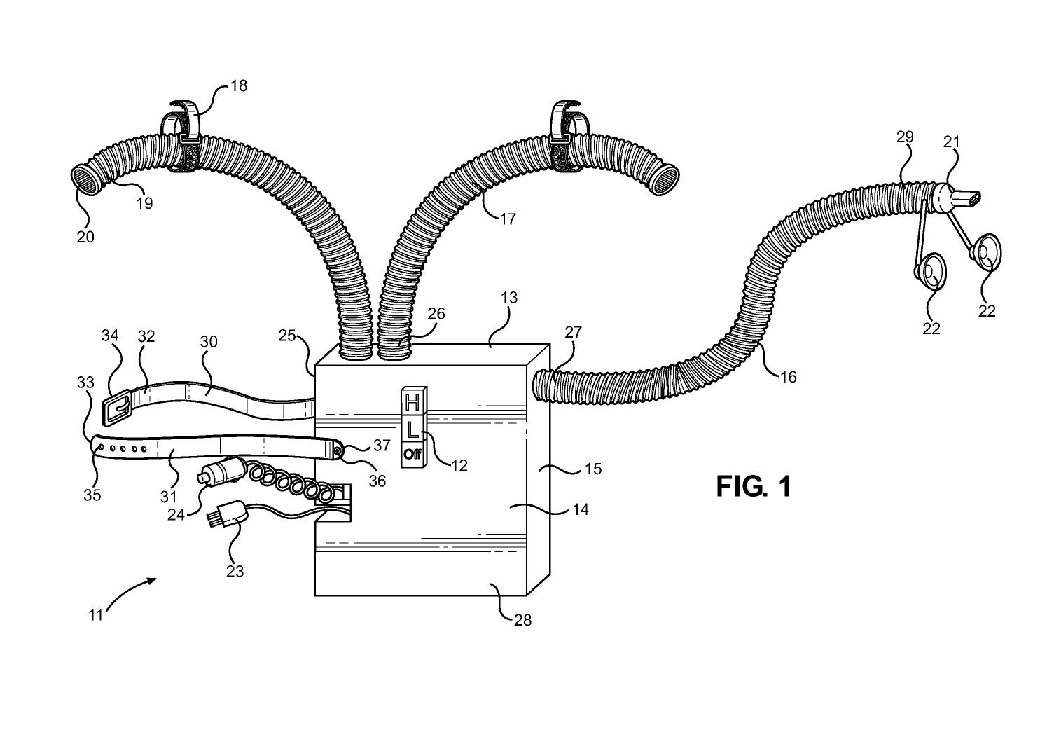

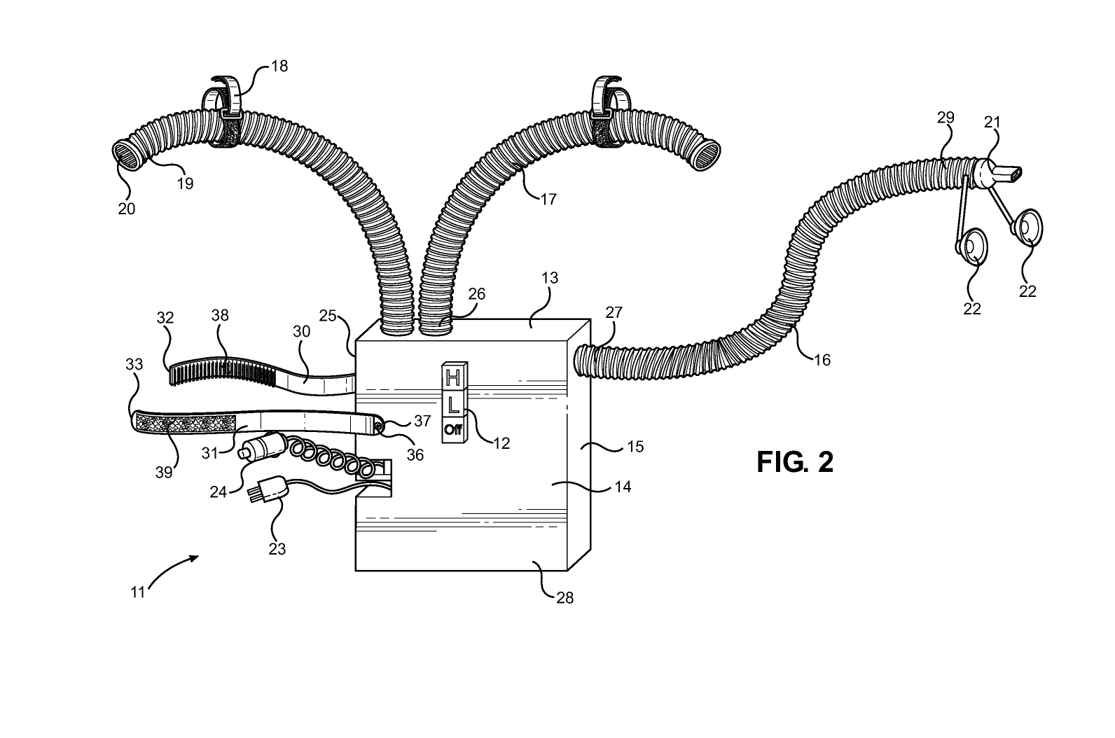

Referring now to FIGS. 1 and 2, there are shown perspective views of various embodiments of the present invention. The present invention is a vehicle air conditioning unit 11 that uses a thermoelectric cooling module to exchange heat, and that can be used as a heating or cooling device as desired by the user. The present air conditioning unit 11 comprises a housing 28 that is composed of rigid material such as durable plastic or thin metal. The housing 28 preferably comprises a rectangular prism shape having a top side 13, a bottom side, a front side 14, a back side, a first lateral side 25, and a second lateral side 15, forming an interior volume adapted to enclose various components of the air conditioner therein. The top side 13 of the housing 28 comprises one or more outlet ports, wherein each port is connected to an air duct hose 17 so that the air duct hose 17 is in fluid communication with the interior volume of the housing 28. In the illustrated embodiment, the top side 13 comprises two outlet ports so that the device comprises two air duct hoses 17, wherein one air duct hose can be used to direct heated or cooled air towards the driver and another air duct hose can be used to direct heating or cooled air towards the front passenger. However, the air duct hoses 17 may be used to direct heated or cooled air to any part of the vehicle where air flow is desired.

Each air duct hose 17 may be manufactured from one or more plastic materials and may have a flexible, accordion-like structural configuration to facilitate movement thereof. The air duct hose 17 comprises a first end 26 and a second end 19, wherein the first end 26 is connected to the outlet port disposed on the top side 13 of the housing 28. The perimeter of the first end 26 is sealed around the outlet port to prevent air leakage. The second end 19 of the air duct hose 17 comprises an adjustable air vent 20 that enables a user to control the direction and the amount of the air flow. Additionally, the air duct hose 17 comprises a closed loop strap 18 having hook and loop fasteners thereon. The strap 18 may be used to secure the second end 19 of the air duct hose 17 to a desired location inside of the vehicle.

The front side 14 of the housing 28 comprises a fan speed control switch. In the exemplary embodiments, the front side 14 includes a speed control switch 12 for a two-speed fan disposed within the interior volume of the housing 28. More specifically, the exemplary embodiments comprise an off mode, a low speed setting, and a high speed setting. The housing 28 further comprises a control for allowing the user to switch between heating and cooling modes, so that the device can be used to heat or cool the interior of the vehicle as desired by the user. Additionally in some embodiments, the present invention comprises a digital display to show the temperature of the interior of the vehicle in which the air conditioning device is placed.

The first lateral side 25 comprises a recessed portion that is adapted to store retractable power adapters and/or cables 24, 25 therein. More specifically, the device may include a standard outlet plug 23 and a retractable 12-Volt power supply adapter 24. Each of the standard outlet plug 23 and the power supply adapter 24 are electrically connected to the various air conditioner components disposed inside of the housing 28. It is contemplated that each of the standard outlet plug 23 and the power supply adapter 24 is retractable.

Optionally, the second lateral side 15 comprises an exhaust port. The exhaust port is connected to an exhaust hose 16 so that the exhaust hose 16 is in fluid communication with the interior volume of the housing 28. Similar to the air duct hose 17, the exhaust hose 16 may be manufactured from one or more plastic materials and may have a flexible, accordion-like structural configuration to facilitate movement thereof. The exhaust hose 16 comprises a first end 27 and a second end 29, wherein the first end 27 is connected to the exhaust port disposed on the second lateral side 15 of the housing 28. The perimeter of the first end 27 is sealed around the exhaust port to prevent any air leakage therefrom.

The second end 29 of the exhaust hose 16 comprises a tip 21 that is flat in structural configuration, so that it may be held or wedged between the window and the vehicle door frame. In this way, the tip 21 can release hot air produced from the interior of the housing 28 to the outdoors. Additionally, the second end 29 of the exhaust hose 16 comprises one or more suction cups 22 attached thereto. The suction cups 22 may be attached to the exhaust hose 16 via a strap or the like. The suction cups 22 help to secure the second end 29 of the exhaust hose 16 to the window and prevent the exhaust hose 16 from slipping or falling down. Optionally, the exhaust hose 16 may include a warning indicator to alert the user of the heated air that is blown from the tip 21.

The housing 28 may further comprise a strap system so as to secure the present invention to a back of a vehicle seat. The strap system comprises a first strap 30 and a second strap 31. The straps 30, 31 may be composed of durable material such as nylon, polyester, polypropylene, leather, or other suitable material. The first strap 30 comprises a proximal end that is attached to the back side of the housing 28, and a free distal end 32. Similarly, the second strap 31 comprises a proximal end 36 that is attached to the front side 14 of the housing 28, and a free distal end 33. The proximal ends of the straps 30, 31 may be attached to the front side 14 and the back side of the housing 28 via a fastener 37 such as a screw. The distal end 32 of the first strap 30 may comprise a buckle 34, which can engage one of the apertures 35 disposed near the distal end 33 of the second strap 31, as shown in FIG. 1. Alternatively, the distal end 32 of the first strap 30 may comprise hook fasteners 38, which can engage loop fasteners 39 disposed on the distal end 33 of the second strap 31, as shown in FIG. 2.

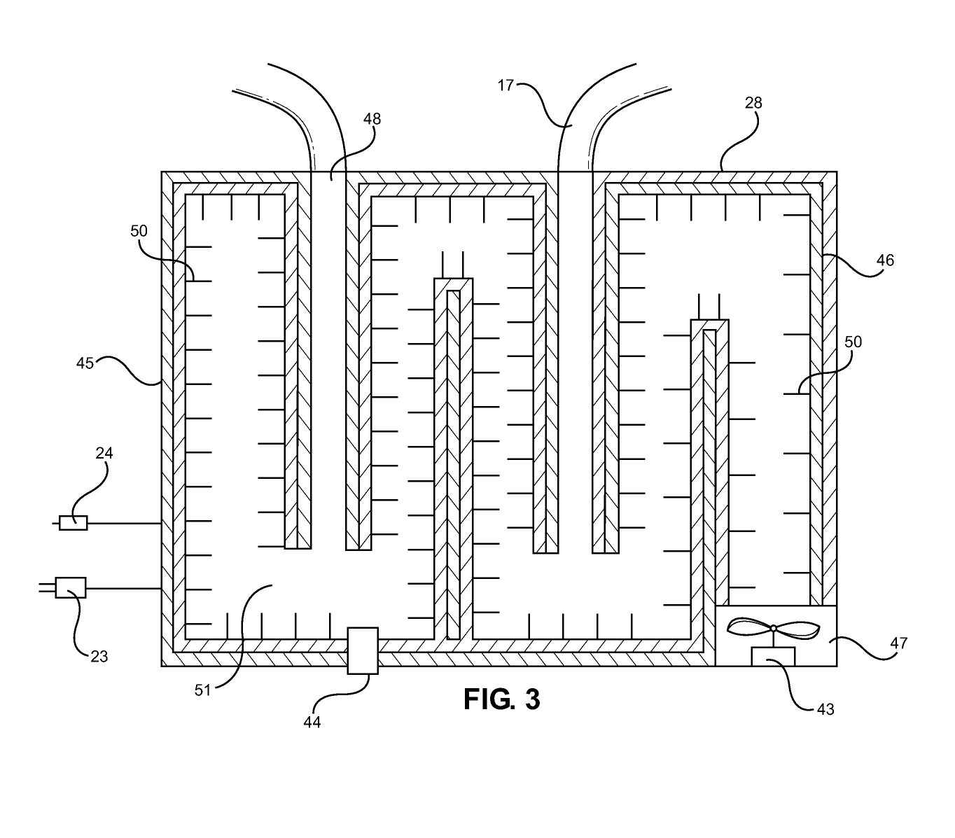

Referring now to FIG. 3, there is shown a cross sectional view of the air conditioning unit of the present invention. The housing 28 of the air conditioning unit 11 comprises an outer layer 45 and an inner layer 46. The outer layer 45 comprises ceramic heat insulation and the inner layer 46 comprises a thermoelectric cooling module adapted to produce heated or cooled air, wherein the thermoelectric cooling module spans the entire surface area of the inner layer 46. Preferably, the outer layer 45 is substantially coextensive with the inner layer 46. Additionally, the outer layer 45 and the inner layer 46 form a channel 51 in the interior volume of the housing 28. The channel 51 provides access to the outlet port 48 disposed on the top side of the housing 28 and to the inlet port 47 disposed on the bottom side of the housing 28.

The thermoelectric cooling module of the inner layer 46 comprises a cool side, a hot side, and a plurality of metal conductors and thermoelectric N, P elements therebetween. The cool side and the hot side comprise ceramic plates. The cool side faces the interior of the housing 28 and the hot side faces the outer layer 45 of the housing 28. Thus, heat is absorbed from the cool side in the interior of the housing 28, then transmitted to the hot side. The cool side comprises a plurality of aluminum plates 50 perpendicularly attached thereto. As such, the aluminum plate protrudes toward the interior of the housing 28. In the illustrated embodiment, the aluminum plates 50 are rectangular in shape and are separated at regular intervals so as to cool the air in a uniform manner. Each aluminum plate comprises a plurality of apertures thereon to allow air to pass therethrough. Because the aluminum plates have good thermal conductance to provide heat transfer with minimal resistance, the aluminum plates 50 increase the efficiency of the device by facilitating in cooling or heating the air within the channel 51.

The inlet port 47 comprises a two-speed fan 43 therein. The fan speed may be determined via the fan speed control switch disposed on the exterior of the housing 28. The fan 43 is adapted to force the heated or cooled air through the channel 51 and exit through the outlet ports 48. In some embodiments, the inlet port 47 may further comprise an air filter to eliminate any debris before the air is directed toward the outlet port 48 connected to the air duct hose 17. The filter may be in a form of pleated fibrous materials which removes solid particulates such as dust, pollen, mold, and bacteria from the air.

The heat generated from the energy spent to cool the air may be released through the exhaust port connected to the exhaust pipe. Alternatively, the heat may be released through the inlet port 47 or cooled within the interior of the housing as the heat travels through the channel 51. Accordingly, some embodiments of the present invention may not comprise an exhaust port. Any condensation or moisture formed within the interior of the housing may be released through an opening disposed on the bottom side of the housing, wherein the opening may be closed or opened via a plug 44.

It is contemplated that the present invention may be powered externally via a vehicle battery or a solar panel connected thereto. Accordingly, the housing 28 comprises a plurality of power cords and plugs 23, 24, wherein the power cords and plugs 23, 24 are in electrically connected to the thermoelectric cooling module and the fan 43. In other embodiments, however, the present invention may be powered internally via a battery.

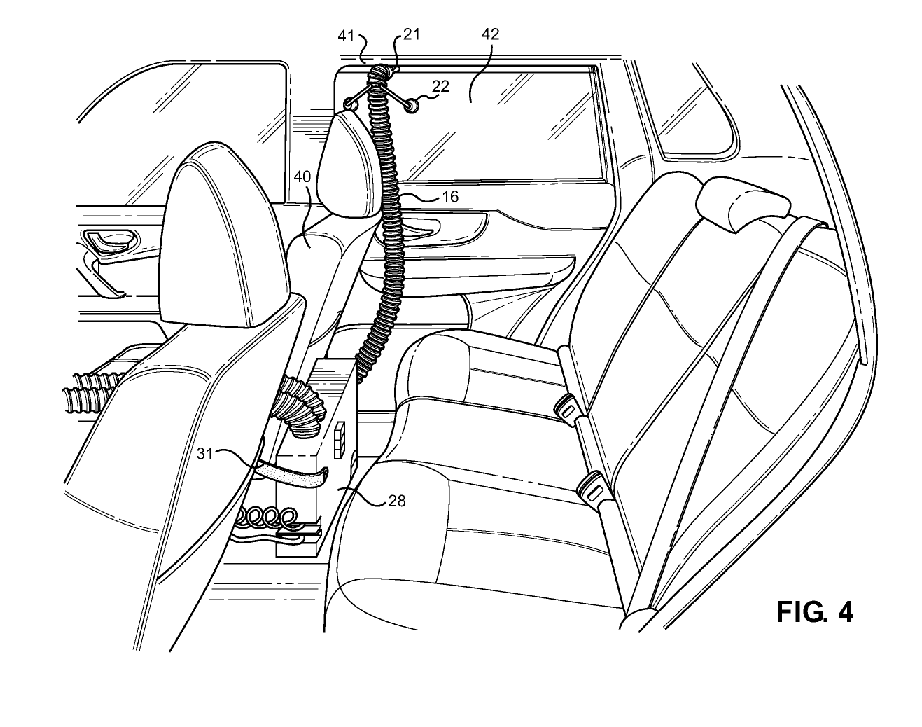

Referring now to FIG. 4, there is shown a view of the present invention as placed inside of a vehicle. The device is placed inside of a vehicle, such as the area behind the front seat of the vehicle, or the area behind the center console. The housing 28 may be secured to the front seat 40 or to the center console, and remain secured thereto via straps 31. The outlet ports direct air through the air duct hoses which can be disposed in the front of the vehicle so as to provide heated or cooled air to the driver and passenger. The tip 21 of the exhaust hose 16 may be extended toward the window 42, and wedged between the window 42 and the vehicle door frame 41. The tip 21 of the exhaust hose 16 should face outward to direct hot air produced from the device to the outdoors. Additionally, the suction cups 22 may be placed on the window 42 to prevent the exhaust hose 16 from falling off of its place. Releasing hot air to the outdoors increases the efficiency of the present invention by maintaining cool temperature inside of the vehicle.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A portable air conditioning device for vehicles, comprising:
a housing with a defined interior volume;
said interior volume having a fan and a thermoelectric cooling module;
a fan speed control switch for operating said fan;
at least one inlet port and at least one outlet port disposed on said housing;
at least one flexible air duct hose connected to said at least one outlet port such that said at least one flexible air duct hose is in fluid communication with said interior volume of said housing;
at least one power plug in electrical communication with said fan and said thermoelectric cooling module.

2. The portable air conditioning device of claim 1, further comprising:
an exhaust port disposed on said housing;
a flexible exhaust hose connected to said exhaust port such that said flexible exhaust hose is in fluid communication with said interior volume of said housing.

3. The portable air conditioning device of claim 2, further comprising a flat tip at an end of said flexible exhaust hose.

4. The portable air conditioning device of claim 2, further comprising at least one suction cup attached to an end of said flexible exhaust hose.

5. The portable air conditioning device of claim 2, wherein said flexible exhaust hose is accordion-like.

6. The portable air conditioning device of claim 1, wherein said at least one flexible air duct hose comprises an adjustable vent at an end thereof.

7. The portable air conditioning device of claim 1, wherein said at least one power plug is retractable.

8. The portable air conditioning device of claim 1, wherein said at least one flexible air duct hose is accordion-like.

9. The portable air conditioning device of claim 1, wherein said housing comprises
an outer layer and an inner layer;
said outer layer comprising ceramic heat insulation;
said inner layer comprising said thermoelectric cooling module;
wherein said thermoelectric cooling module spans entire said inner layer.

10. The portable air conditioning device of claim 9, wherein said outer layer and said inner layer form a channel within said interior volume of said housing.

11. The portable air conditioning device of claim 9, wherein said thermoelectric cooling module comprises a cool side and a hot side;
said cool side facing said interior volume of said housing;
said hot side facing said outer layer.

12. The portable air conditioning device of claim 9, further comprising a plurality of aluminum plates perpendicularly attached to said thermoelectric cooling module.

13. The portable air conditioning device of claim 12, wherein said plurality of aluminum plates are separated at regular intervals.

14. The portable air conditioning device of claim 12, wherein each of said plurality of aluminum plates comprises a plurality of apertures thereon so as to allow air to flow therethrough;
whereby allowing said air to flow through said plurality of apertures cools or heats said air.

15. The portable air conditioning device of claim 1, wherein said least one power plug comprises a power adapter.

16. The portable air conditioning device of claim 1, wherein said least one power plug comprises an electrical outlet plug.

17. The portable air conditioning device of claim 1, further comprising a strap system attached to said housing.

18. The portable air conditioning device of claim 17, wherein said strap system comprises a first strap having a buckle and a second strap having a plurality of apertures thereon.

19. The portable air conditioning device of claim 17, wherein said strap comprises a first strap having hook fasteners and a second strap having loop fasteners.
